(19) United States
(12) Patent Application Publication
(10) Pub. No.: US 2007/0293271 A1
(43) Pub. Date: Dec. 20, 2007

(54) System that augments the functionality of a wireless device through an external graphical user interface on a detached external display

(76) Inventor: Leslie-Anne Streeter, Blue Bell, PA (US)

Correspondence Address: LESLIE-ANNE STREETER, 855 FIELDCREST COURT, BLUE BELL, PA, 19422, US

(21) Appl. No.: 11/409,317

(22) Filed: Jun. 16, 2006

(51) Int. Cl. H04B 1/38

(52) U.S. Cl. 455/566

(57) ABSTRACT

This invention relates to the Design and Concept for a system that augments the functionality of a wireless data device by extending the functionality of said device via a graphical and/or textual user interface on a detached display which interacts with said device via wireless communication. The system enables the capability to collect user input on the detached display and transmit that input to the wireless device for processing. This invention also relates to methods and a system for optimizing the wireless communication transmissions for multiple applications and/or devices in order to effectively share the communication path. This invention also relates to methods and a system for rendering the graphical output from applications to a detached display which may be of a different size and resolution than the integrated display of the wireless data device. This invention also relates to methods and a system for limiting the display and functionality for various purposes including, but not limited to, safety, security and parental control. This invention also relates to the Design and Concept for a system that augments the functionality of a wireless data device by extending the functionality of said device via a graphical and/or textual user interface on a detached display which interacts with said device via a wired connection. This invention also relates to the Design and Concept for a system that enables a display device to provide navigation services driven by location data that is attained external to said display device.

### CROSS-REFERENCE TO RELATED CLAIMS

Not applicable

### BACKGROUND OF THE INVENTION

Up to this point, there has not been a system that allows users of wireless data devices to access a larger supplementary detached display, interacting wirelessly. This system is designed to make wireless data applications more usable.

Current systems have visual displays that are too small for the practical use of many software applications. Current systems do not have the capability to extend the functionality of a wireless device to an external graphical interface on a wireless external display.

Because of these foregoing limitations in the prior art, it is an intent of this invention to provide wireless data users with a detached, wireless display and a system that enables software applications to be more usable with a wireless data device. Software applications that will be enhanced include, but are not limited to, navigation services, traffic services, news services, directory services, location services, messaging services, and video services.

Up to this point, there has not been a dash board mounted navigation system that leverages the functionality of external devices and systems to provide navigation services. The system is designed to create a supplementary detached display that leverages the capabilities of other devices to provide navigation services on a device in a more efficient manner than existing systems.

### BRIEF SUMMARY OF THE INVENTION

This invention seeks to create an external display for the user which is larger than that which is currently found on typical wireless data devices. This larger display will allow the user to view and interact with more information simultaneously.

This external display will interact with the wireless data device via a wireless connection.

The images presented to the user on the external display may be generated from software executing on the external display, the wireless data device, or another server.

The invention is intended to be portable and separate from the wireless data device.

The invention is intended to be either hand held or mounted, temporarily or permanently, in a vehicle.

The invention is intended to provide navigation services on the detached display. The detached display is intended to leverage the functionality of other devices to provide location capability and navigation functionality.

### BRIEF DESCRIPTION OF THE DRAWINGS

FIG. 1 relates to the System that augments the functionality of a wireless device by extending the functionality of said device via a graphical and/or textual user interface on a detached display.

FIG. 2 depicts a block diagram of the detached display.

FIG. 3 depicts the detached display connected to a wireless data device via a wireless link.

FIG. 4 depicts an external keyboard, user input device, connected to the detached display via a wired connection.

FIG. 5 depicts an external keyboard, user input device, connected to the detached display via a wireless connection.

FIG. 6 depicts a wireless data device communicating with multiple devices, including a detached display while operating simultaneous applications.

FIG. 7 is an expansion of FIG. 1 to illustrate image rendering from a server.

FIG. 8 depicts a detached display connected to a wireless data device via a wired connection.

FIG. 9 depicts a high level functional system diagram of a system to provide navigation services on a detached display.

### DETAILED DESCRIPTION OF THE INVENTION

This invention relates to a system that augments the functionality of a wireless device by extending the functionality of said device via a graphical and/or textual user interface on a detached display which interacts with said device via wireless communication. The system enables the capability to collect user input on the detached display and transmit that input to the wireless device for processing.

The detached display is physically larger than displays on typical wireless data devices, which will allow information to be displayed to the user more clearly and concisely.

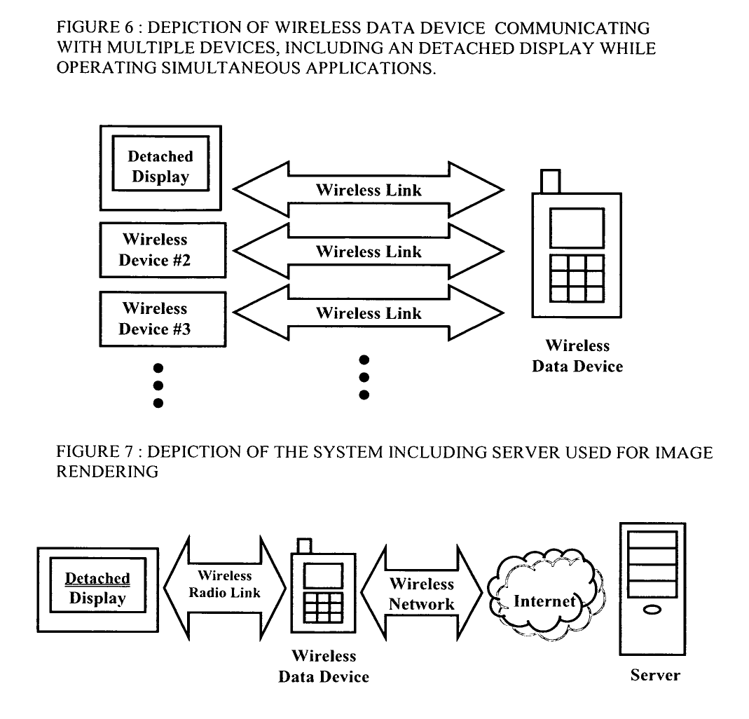

The System and Method for enabling wireless devices to simultaneously support multiple applications on a detached display, as well as other devices that communicate via the wireless link. In FIG. 6, the other devices are represented by wireless device #2, wireless device #3, etc. The system has the capability to monitor performance metrics on the wireless link, including, but not limited to availability, throughput, bandwidth, latency, error rate, and pending requests. The system will have the capability to, as necessary, reduce the data throughput to the external display on a per application basis in order to maximize the overall performance of applications utilizing the wireless link. The maximum data rate to the external display will equal the maximum data rate supported by the wireless link. This maximum rate is intended to support real-time video. The minimum operational data rate to the external display will transmit a static image every x seconds, where x is a variable that will vary based on the data refresh requirements of the specific application. In the event the full capacity of the wireless link is needed to support critical applications on other devices, data transmission to the wireless display can be temporarily disabled.

The Method to support simultaneous usage includes a per application prioritization utilizing a number of attributes to assess the overall priority. The prioritization is configurable on a per user basis. The prioritization is state dependent, and the priority of an application can be different when the system is in different states. A list of attributes may include, but is not limited to:

### Wireless Data Device Speed

### Wireless Data Device Direction of Travel

### Wireless Data Device Location

### User Type (primary, secondary, child, visiting, etc.)

### Authentication

### Safety (911 type services, etc.)

### Availability

### Throughput

### Bandwidth

### Latency

### Error rate

### Pending Requests for each device

### Pending Requests for the wireless link

Partial display sends is a process by which the transmitting device only sends a partial display image to the receiving device once every time period. This partial image may be any subset of the entire display. Examples include only transmitting a quadrant of the total image, half the total image, only the image changes from the previous transmission, etc.

The intent of sending a partial display is to minimize the wireless bandwidth needed to perform the transmission. By leaving wireless bandwidth under utilized, multiple wireless devices can be co-located and error recovery codes can be used to minimize wireless disturbances. Example: The total display size is 320 pixels wide by 240 pixels high. Each pixel is represented by a 4 bit binary numeral, for a total of 16 display colors. If the transmitting device intended to send one complete image per second, the transmitting device would have to transmit 320×240×4=307,200 bits per second. By only transmitting one quadrant of the display per second, the wireless bandwidth needed would be reduced by 25% to 76,800 bits per second. If 256 display colors (8 bits) are used and only one quadrant is transmitted per second, the total bits per second transmitted falls from 614,400 bits to 153,600 bits.

The intent of rendering images on the wireless data device and transmitting them to the detached display for display on the LCD panel is to minimize the amount of processing required on the detached display. Not requiring the capability to render images on the detached display reduces the cost and complexity of the detached display. The detached display leverages the computer processing power of the wireless data device to maintain a cost that is significantly lower than products that currently exist in the market.

The intent of rendering images from a server and transmitting them to the detached display via a proxy on the wireless data device for display on the LCD panel is to minimize the amount of processing required on the detached display. Not requiring the capability to render images on the detached display reduces the cost and complexity of the detached display. The detached display leverages the computer processing power of the wireless data device and the server to maintain a cost that is significantly lower than products that currently exist in the market.

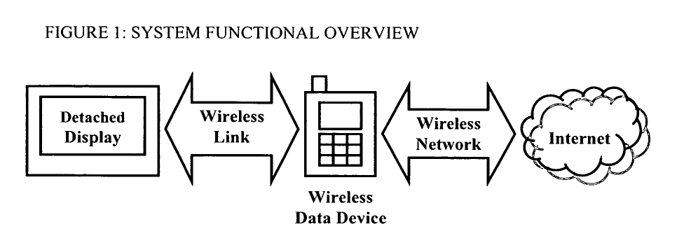

Through various mechanisms, the system may have the capability of detecting when the vehicle, in which it is mounted, is moving. The system may accomplish this by various means, including, by not limited to, using successive geographical locations to discern that the vehicle is in motion. The geographical locations can be obtained from many sources, including a GPS source. A GPS source may be included in the wireless data device, or a GPS source may be included in the detached display. The geographical locations may also be obtained from an external wireless location system that processes the location of the wireless data device. The wireless location may use a wide variety of technologies to process the location, including Assisted GPS, TDOA or other available technologies. The wireless location system is generally a part of the Wireless Network, as shown in FIG. 1.

Classes of functionality include Input functionality, categorized content display (only navigation apps can be displayed when moving), etc.

Authentication may include an equipment ID and/or user ID on both the detached display and the wireless data device. Authentication may include entering a pass code through any type of user input allowed by the system. Authentication may be used for theft prevention and device conflict resolution.

The detached display and wireless data device may be separated by a physical distance.

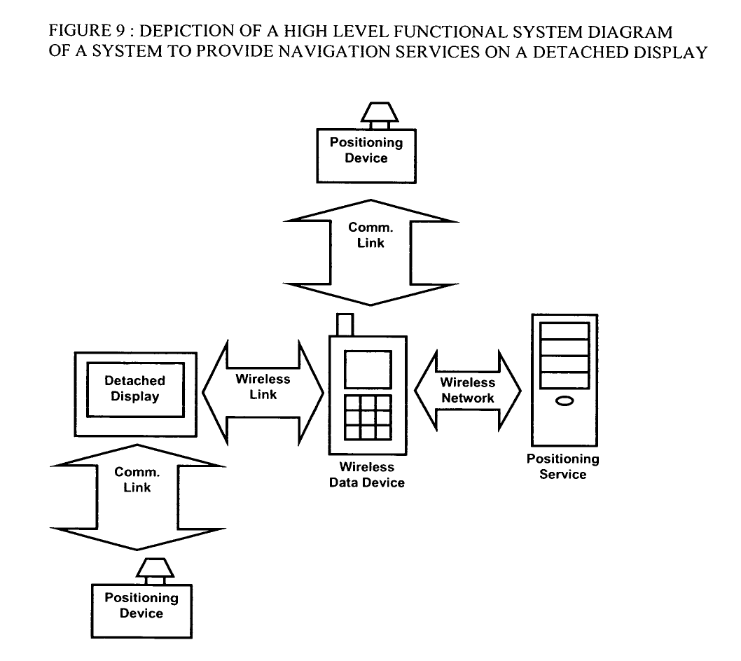

The invention is intended to have the capability to provide navigation services, as well as other services, on the detached display. FIG. 9 depicts a high level functional system diagram of a system that provides navigation services on a detached display. The detached display leverages the functionality of other devices to provide location capability and navigation functionality. The intent of leveraging other devices is to provide a more efficient solution than existing systems. The geographical location capability needed for navigation services may be provided, in whole or in part, by a combination of one or more of the following sources as defined in FIG. 9:
a) One or more positioning devices
b) A wireless data device (operating as a positioning device)
c) A positioning service

The navigation functionality needed for navigation services may be provided, in whole or in part, by a combination of one or more of the following sources of navigation information as defined in the description of FIG. 9:
a) A wireless data device
b) A server, as defined in FIG. 7
c) A positioning service

FIG. 1 relates to the overall System that extends the functionality of a wireless device through an external graphical user interface on a detached external display. The invention relates the detached display, the wireless link and software and algorithms utilized on the wireless data device. The wireless data device, the wireless network and the Internet are depicted in the diagram to provide a frame of reference for the invention and are covered by prior art.

Definition—detached display: The detached display is a separate device from the wireless data device. The detached display communicates with the wireless data device via wireless communication. The detached display may contain the following major components:
a) electronic display
b) power supply
c) microprocessor
d) wireless chipset
e) wireless antenna
f) speakers
g) microphone

Definition—wireless link: The wireless link is the RF (Radio Frequency) communication path for communication between the detached display and the wireless data device. Communication protocols appropriate for the wireless chipset may include, but are not limited to the following technologies:
a) Bluetooth
b) Zigbee
c) Wireless Universal Serial Bus (USB)
d) Ultra Wide Band Communication

Definition—wireless data device: A wireless data device is any wireless device that allows data content to be delivered via a wireless method from a host server. Examples of wireless data devices include, but are not limited to:
a) Cellular telephones
b) Smart phones
c) Wireless PDAs
d) Wireless pagers

Definition—electronic display: An electronic display can be, but is not limited to, a liquid crystal display (LCD) panel, a plasma display panel, or a cathode ray tube (CRT) display. The electronic display may or may not include touch screen capability so that the user can input data through touching the display.

Definition—power supply: The power supply generates voltages and current used for electronics sourced from an external Direct Current (DC) or Alternating Current (AC) source.

Definition—microprocessor: The component of the detached display that is used to command and control the individual components of the display. This may be a single physical component or several.

Definition—Radio Frequency (RF) chipset or other wireless chipset: This component enables the capability to communicate with the wireless data device via wireless communication. Communication protocols appropriate for the wireless chipset may include, but are not limited to the following technologies:
a) Bluetooth
b) Zigbee
c) Wireless Universal Serial Bus (USB)
d) Ultra Wide Band Communication

Definition—wired connection: A multi-wire cable with the capability of providing a bidirectional communication path between the detached display and the wireless data device. Protocols supported on the wired connection may include, but are not limited to the following list:
a) Universal Serial Bus (USB
b) IEEE 1394 (also known as Fire Wire)
c) RS-232 Serial
d) RS-422 Serial
e) RS-485 Serial

### The wired connection may or may not provide power to the Wireless Data Device.

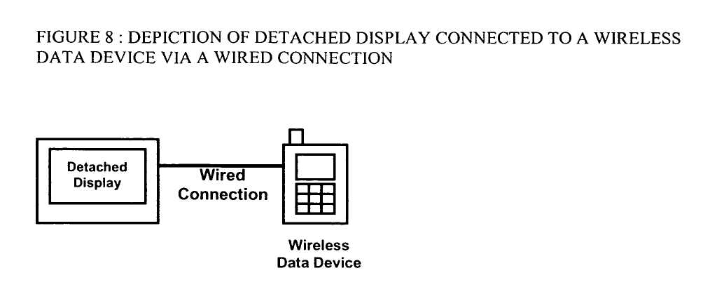

Definition—communication link (abbreviated as comm. link in FIG. 9): A communication link is defined as a bi-directional communication link. It may include, but is not limited to the following functionality:
a) a wireless link, as defined in the description of FIG. 1
b) a wired connection, as defined in the description of FIG. 8

Definition—positioning device: A positioning device has the capability to determine its own is geographic location. The wireless data device may or may not include the capability of a positioning device. The system may utilize, but is not limited to, latitude and longitude coordinates as the means for recording the location of the positioning device. The positioning device may or may not require interaction with a positioning service to determine a geographic location. The mechanism for calculating the location of the positioning device may include, but is not limited to use of the following systems:
a) global positioning system (GPS)
b) assisted global positioning system (AGPS)
c) differential global positioning system (DGPS)
d) wide-area differential global positioning system (WADGPS)
e) global orbiting navigation satellite system (GLONASS)
f) inertial navigation system (INS)
g) uplink time difference of arrival (uTDOA)
h) cell global identity (CGI)
i) timing advance (TA)
j) enhanced cell identification (ECID)

Definition—positioning service: A positioning service works in conjunction with a positioning device to determine the geographic location of said positioning device. Depending upon the type of positioning device, a positioning service may or may not be required for the positioning device to discern a location. The location service may be, but is not limited to, one of the following technology standards:
a. a Position Determining Entity (PDE), or
b. a Serving Mobile Location Center (SMLC)
c. a GMLC or MPC

Definition—navigation service: A navigation service is primarily intended for, but not limited to, in-vehicle use. The service may include, but is not limited to providing the following functionality:
d. Displaying the geographical location of the detached display on a map that may include, but is not limited to, the following:
   i. Streets, roads, highways, etc.
   ii. Traffic information
   iii. Direction of travel
   iv. Speed of travel
   v. Points of Interest
e. Turn-by-turn directions service, which displays turn-by-turn directions from the current position of the detached display to the intended destination. As the detached display approaches intersections, the turn-by-turn direction service notifies the user of any upcoming decisions, including, but not limited to:
   i. Turning right
   ii. Turning left
   iii. Continuing forward
   iv. Slowing down
   v. Destination arrival notification
The notification method for the turn-by-turn directions may include, but it not limited to visual indications, and audio messages
f. 411 directory service, providing the capability to find locations of interest that are in proximity of the detached display.
Locations of interest may include, but are not limited to:
   i. Restaurants
   ii. Hotels
   iii. Stores
   iv. Rest Areas
   v. Sites of Interest

Definition—navigation information: Navigation information is required for the navigation service to operate. The following categories of navigation information may be utilized by the system:
a) Geographical location (defined below)
b) Street data, road data, highway data, bridge data and similar
c) Traffic information
d) Terrain data
e) Geographical data for restaurants, hotels, stores, rest areas and other points of interest

Definition—geographical location: The geographical location defines the coordinates for the location of the positioning device, from which the location of the detached display can be deduced within a reasonably margin of error. The coordinates used for defining the geographical location may be defined by latitude, longitude and elevation. The coordinates may alternatively be defined by a proprietary coordinate system.

1. Design and Concept for a system that augments the functionality of a wireless data device by extending the functionality of said device via a graphical and/or textual user interface on a detached display which interacts with said device via wireless communication. By utilizing a detached display along with wireless communication between the device and the display, user interaction with the software on the wireless data device can be extended to an augmented graphical and/or textual interface on the detached display. FIG. 1 shows a high level diagram of the system.

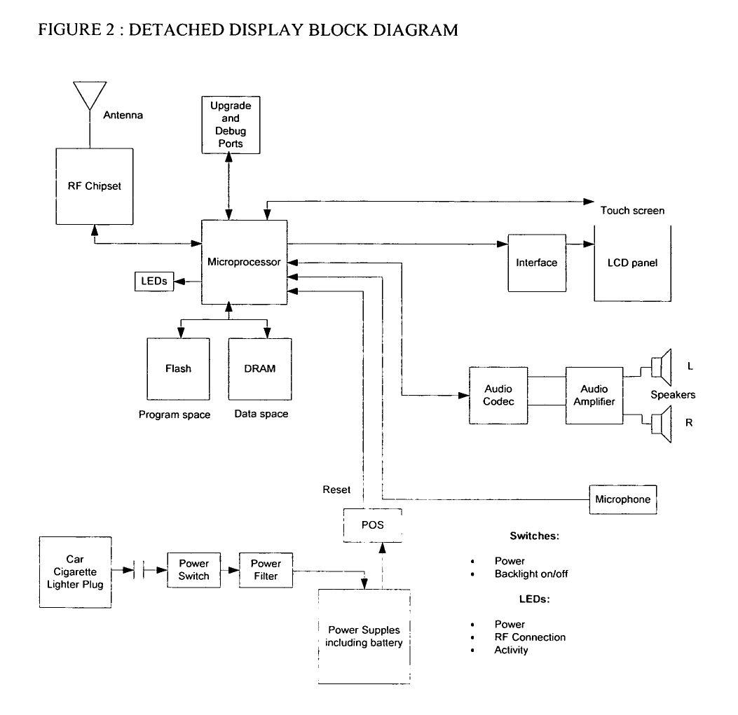

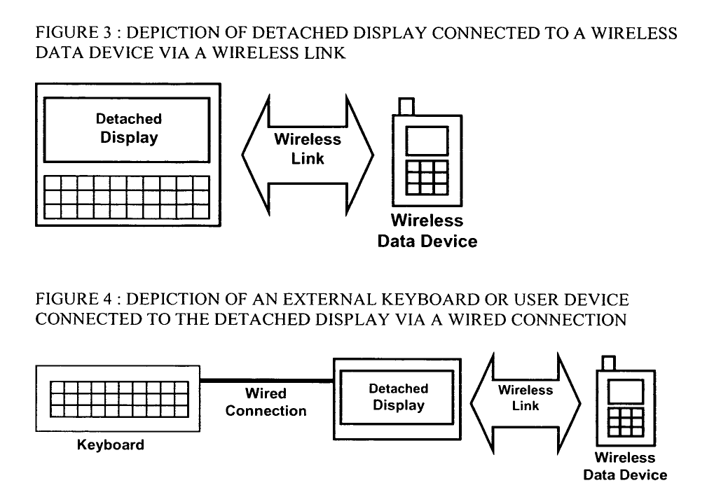

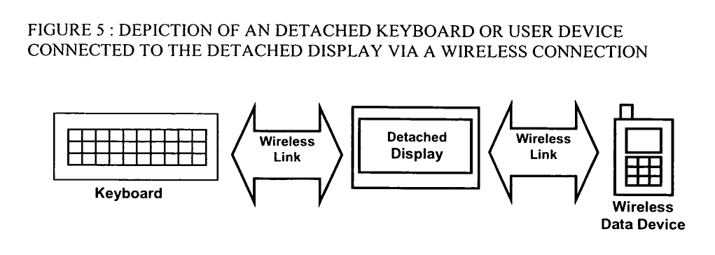

2. The detached display in claim 1 including the capability to collect user input via various mechanisms, including but not limited to an integrated keyboard (see FIG. 3), a wired keyboard (see FIG. 4), a wireless keyboard (see FIG. 5), a touch screen display, and voice interaction using the microphone and speakers on the detached display (see FIG. 2). This user input is relayed to the wireless data device via the wireless link shown in FIG. 1 wherein software running on the wireless data device will process the input.

3. Based on the System in claim 1 and claim 2, a System and Method for wireless devices which enables simultaneous usage of applications on a mobile device and a detached display while sharing the wireless link, as described in claim 1 and claim 2.

4. Based on the System in claim 3, a Method to minimize the amount of data transferred on the wireless link to maximize the capacity of the system and further enhance the capability to effectively support simultaneous usage.

5. Based on the System in claim 3, a Method for rendering images in an application on the wireless data device for eventual presentation on the detached display. This is accomplished through custom software for intercepting, or duplicating, the video output (what is, or is intended, to be rendered on the display of the wireless device) of a wireless data device, and directing that output to an alternate or supplementary external device, such as, but not limited to, a detached display. The images to be rendered are transmitted to the detached device via wireless communication.

6. Based on the System in claim 3, a Method for rendering images in an external server as shown in FIG. 7. Images are rendered on the server and sent through the wireless device for eventual presentation on the detached display. Custom software enables the wireless device to function as a proxy in order to facilitate the end-to-end (server to detached display) image transfer.

7. Based on the System in claim 2, a System and Method designed to limit classes of functionality when the system is in motion. Through various mechanisms, the system may have the capability of detecting when the system is moving.

8. Based on the System in claim 2, a rating system for classes of functionality. The system may have a rating system for determining what functionality should be limited, or disabled, when the system is in motion, as in claim 7. This rating system may be able to classify functionality based upon whether the system is in motion, and may also be able to further classify functionality based upon the speed for which the system is moving. This rating system may also classify functionality based on geographical location. This rating system may also classify functionality based on the type of user. Based upon the rating system the system will automatically disable/enable functionality without further intervention. The rating system may, or may not, be user modifiable.

9. Based on the System in claim 2, a Method for authentication and authorization which may be required in order to permit system use. This mechanism may allow/disallow complete system access (useful for, but not limited to, theft prevention), and/or it may limit access to certain functionality based upon the supplied authentication credentials. The system may also provide a mechanism for authenticating access to a wireless device, and furthermore distinguish between multiple compatible devices which may be in communication range.

10. A variant of claim 1, a Design and Concept for a system that augments the functionality of a wireless data device by extending the functionality of said device via a graphical and/or textual user interface on a detached display which interacts with said device via wired communication. By utilizing a detached display along with wireless communication between the device and the display, user interaction with the software on the wireless data device can be extended to an augmented graphical and/or textual interface on the detached display. FIG. 8 depicts the wireless data device.

11. Based on the System in claim 1 and claim 2, a System and Method for providing navigation service on the detached display by utilizing navigation information attained from a device or system external to the detached display. FIG. 9 depicts a system diagram for claim 11.
